(19) United States
(12) Patent Application Publication
(10) Pub. No.: US 2026/0153269 A1
(43) Pub. Date: Jun. 4, 2026

(54) CONTROLLER AND PROCESS TO OPERATE A WATER HEATER

(71) Applicant: ADEMCO INC., Golden Valley, MN (US)

(72) Inventor: Christopher E. Heintzelman, St. Paul, MN (US)

(73) Assignee: RESIDEO LLC, Golden Valley, MN (US)

(21) Appl. No.: 19/134,487

(22) PCT Filed: Dec. 5, 2023
(86) PCT No.: PCT/US2023/082596

§ 371 Date: May 30, 2025

Related U.S. Application Data
(60) Provisional application No. 63/386,131, filed on Dec. 5, 2022.

(51) Int. Cl. F24H 15/174; F24H 15/215; F24H 15/219; F24H 15/238; F24H 15/269; F24H 15/315; F24H 15/355; F24H 15/457; G05D 23/19

(52) U.S. Cl. CPC F24H 15/174; F24H 15/215; F24H 15/219; F24H 15/238; F24H 15/269; F24H 15/315; F24H 15/355; F24H 15/457; G05D 23/1905

(57) ABSTRACT

A method may heat unheated water using a heating unit of the water heater thereby providing heated water. The method may mix heated water with unheated water using a mixing valve of the water heater thereby providing mixed water to at least one water consumer, the mixed water having a desired consumer water temperature. The method may determine the desired consumer water temperature of the mixed water provided to the at least one water consumer. The method may operate the heating unit of the water heater on basis of the determined desired consumer water temperature using a controller of the water heater such that the water temperature of the heated water corresponds to the desired consumer water temperature of the at least one water consumer thereby minimizing the amount of unheated water mixed with the heated water.

### CROSS-REFERENCE TO RELATED APPLICATIONS

This application claims priority to U.S. Provisional Application No. 63/386,131, filed on Dec. 5, 2022, and entitled “CONTROLLER AND PROCESS TO OPERATE A WATER HEATER,” the entire contents of which are hereby incorporated by reference.

### TECHNICAL FIELD

The disclosure relates to a process and a controller to operate a water heater, as well as a configuration for a water heater.

### BACKGROUND

A water heater is a device that is configured to heat potable water and to pro-vide the heated water to at least one water consumer. Water heaters known from prior art typically include a heating unit, example given a gas burner or an electrical heater, configured to heat unheated water thereby providing heated water. The energy provided by the heating unit may be used to heat water stored within a water tank of the water heater or to heat water flowing through a heat ex-changer of the water heater.

### BRIEF DESCRIPTION OF DRAWINGS

References are made to the accompanying drawings that form a part of this disclosure and that illustrate embodiments in which the systems and methods described in this Specification can be practiced.

FIG. 1 shows an example of a water heater.

### DETAILED DESCRIPTION

Water heaters known from prior art use the heating unit to heat the water to a defined water temperature, namely to a peak hot water temperature. If the de-sired consumer water temperature is below said peak hot water temperature, the heated water having the peak hot water temperature becomes mixed with unheated water to provide mixed water to the water consumer having the de-sired consumer water temperature. Mixing heated water and unheated water to deliver mixed water having the desired consumer water temperature is energy inefficient.

Against this background, this disclosures describes processes and a controller to operate a water heater that is configured to allow an energy efficient operation of the water heater. This disclosure also describes a novel water heater configuration.

According to a first aspect, the present disclosure provides a process to operate a water heater. The process to operate a water heater comprises at least the following steps:
Heating unheated water using a heating unit of the water heater thereby providing heated water. Mixing heated water with unheated water using a mixing valve of the water heater thereby providing mixed water to at least one water consumer, the mixed water having a desired consumer water temperature. Determining the desired consumer water temperature of the mixed water provided to the at least one water consumer. Operating the heating unit of the water heater on basis of the determined desired consumer water temperature using a controller of the water heater such that the water temperature of the heated water heated by the water heater corresponds to the desired consumer water temperature of the at least one water consumer thereby minimizing the amount of unheated water mixed with the heated water.

According to a second aspect, the present disclosure provides a controller to operate a water heater. The controller is configured to determine the desired consumer water temperature of the mixed water provided to the at least one water consumer. The controller is further configured to operate the heating unit of the water heater on basis of the determined desired consumer water temperature using a controller of the water heater such that the water temperature of the heated water heated by the water heater corresponds to the desired consumer water temperature of the at least one water consumer thereby minimizing the amount of unheated water mixed with the heated water.

According to a third aspect, the present disclosure provides a water heater. The water heater includes a heating unit configured to heat unheated water (CW) there-by providing heated water (HW), a mixing valve configured to mix unheated water (CW) with heated water (HW) in order to provide mixed water (MW) to at least one water consumer having a desired consumer water temperature, and a controller. The controller may be configured to determine the desired consumer water temperature of the mixed water (MW) provided to the at least one water consumer. The controller may be is further configured to operate the heating unit of the water heater on the basis of the determined desired consumer water temperature such that the water temperature of the heated water (HW) corresponds to the desired consumer water temperature of the at least one water consumer thereby minimizing the amount of un-heated water (CW) mixed with the heated water (HW). The controller may be configured to automatically operate a water heater according to any of the techniques described in this disclosure.

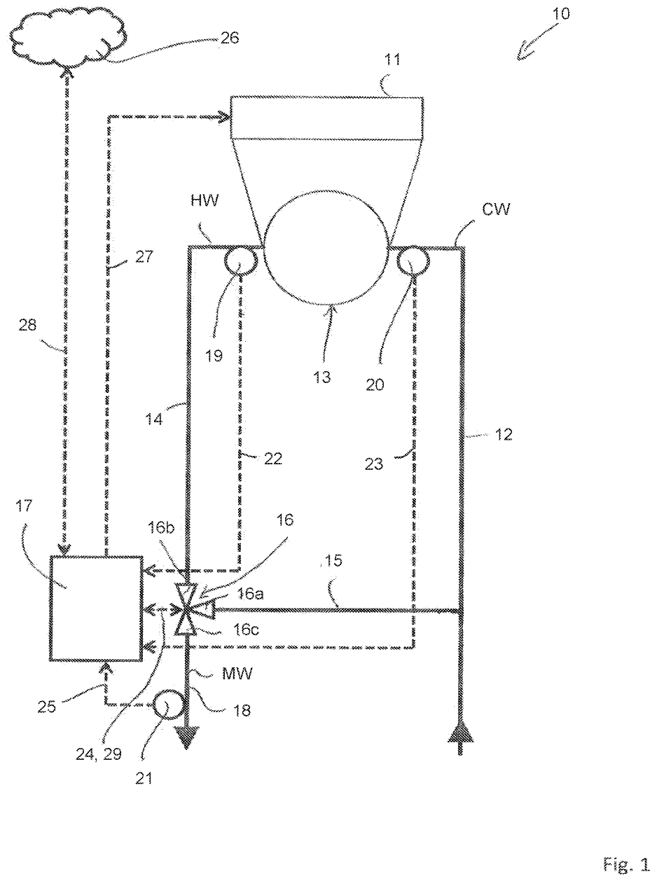

FIG. 1 shows an example of a water heater. The example of FIG. 1 includes water heater 10, heating unit 11, input pipe 12, water handling unit 13, output pipe 14, bypass pipe 15, mixing valve 16, inlet port 16a, inlet port 16b, outlet port 16c, controller 17, supply pipe 18, temperature sensor 19, temperature sensor 20, temperature sensor 21, input data 22, input data 23, input data 24, input data 25, database 26, output signal 27, internet 28, output signal 29. Although not explicitly shown in FIG. 1, the water heater system of FIG. 1, or components thereof, may include various types of memory, such as, but not limited to, the types of memory described below.

The water heater 10 shown in FIG. 1 comprises a heating unit 11 being configured to heat unheated water CW thereby providing heated water HW. The un-heated water CW may also be called cold water. Heated water HW may also be called hot water. The unheated water CW is provided to the water heater 10 through an input pipe 12.

The heating unit 11 may be a gas burner that is configured to combust gas. Such a gas burner comprises a burner chamber and a burner rod within the burner chamber. Gas is provided to the burner rod for combusting the gas with-in the burner chamber. The gas is preferably provided as a gas/air mixture. The combustion of the gas provides thermal energy to heat the unheated water CW.

Alternatively, the heating unit 11 may be an electrical heater like a heating coil. Such an electrical heater is operated by electrical power to provide the thermal energy to heat the unheated water CW.

The water heater 10 further comprises a water handling unit 13.

If the heating unit 11 is provided by a gas burner, the water handling unit 13 is usually provided by a heat exchanger. Unheated water CW flows into the heat exchanger, becomes heated within the heat exchanger using the thermal energy provided by the heating unit 11 and flows out of the heat exchanger as heat-ed water HW.

If the heating unit 11 is provided by an electrical heater, the water handling unit 13 is usually provided by a water tank. Unheated water CW flows into the water tank, becomes heated by the heating unit 11 and is stored with the water tank as heated water HW.

Electrical heaters may also be used if the water handling unit 13 is provided by a heat exchanger. Further on, gas burners may also be used if the water handling unit 13 is provided by a water tank.

The heated water HW is provided to at least one water consumer (not shown) through an output pipe 14 upon a hot water demand by a respective water consumer.

If the water handling unit 13 is provided by a water tank, the heated water HW is stored within the water tank and provided to the water consumer upon a hot water demand by a respective water consumer. The heated water HW provided to the respective water consumer is then renewed within the water tank by providing unheated water CW to the water tank and by heating the same using the heating unit 11.

If the water handling unit 13 is provided by a heat exchanger, the heated water HW becomes heated upon a hot water demand by a water consumer.

FIG. 1 further shows a bypass pipe 15 extending between the input pipe 12 and the output pipe 14. A mixing valve 16 is assigned to the bypass pipe 15 and to the output pipe 14 having two inlet ports and one outlet port, namely one inlet port 16a for unheated water CW, one inlet port 12b for heated water HW and the outlet port 16c for the mixed water MW.

With such a mixing valve 16 both the flow of the heated water HW and the flow of the unheated water can be controlled.

The inlet port 16a of the mixing valve 16 is connected to the bypass pipe 15. The inlet port 16b of the mixing valve 16 is connected to the output pipe 14. The outlet port 16c is connected to a supply pipe 18 through which the mixed water MW can be provided to the at least one water consumer.

The process to operate such a water heater 10 comprises at least the following steps:

Heating the unheated water CW using the heating unit 11 of the water heater 10 thereby providing heated water HW.

Mixing unheated water CW with heated water HW using the mixing valve 16. The unheated water CW is provided to the inlet port 16a of mixing valve 16 and the heated water HW is provided to the inlet port 16b of mixing valve 16. The heated water HW and unheated water CW are mixed by the mixing valve 16.

The mixing of the unheated water CW with the heated water HW results into mixed water MW that is provided to at least one water consumer. The mixed water has a temperature corresponding to a desired consumer water temperature.

Determining the desired consumer water temperature of the mixed water MW provided to the at least one water consumer.

Operating the heating unit 11 of the water heater 10 on basis of the determined desired consumer water temperature using a controller 17 of the water heater 10 such that the water temperature of the heated water HW heated by the water heater 10 corresponds to the desired consumer water temperature of the at least one water consumer. Thereby the amount of unheated water CW mixed with the heated water HW is minimized. This allows an energy efficient operation of the water heater 10.

The desired consumer water temperature of the mixed water MW provided to the at least water consumer may be determined on basis of data provided to the controller 17.

The desired consumer water temperature of the mixed water MW can be determined by the controller 17 on basis of the temperature of the heated water HW, the temperature of the unheated water CW and the flow rates of the heat-ed water HW and unheated water CW through the mixing valve 16. Temperature sensors 19, 20 may provide the temperature of the heated water HW and the temperature of the unheated water CW to the controller 17. Said temperature sensor 19, 20 may provide respective measurement signals as input data 22, 23 to the controller 17. The mixing valve 16 may provide the flow rates of the heated water HW and unheated water CW as input data 24 to the controller 17. The controller 17 is configured to calculate the desired consumer water temperature of the mixed water MW on basis of this input data 22, 23, 24.

The desired consumer water temperature of the mixed water MW provided to the at least water consumer may alternatively be determined by measuring the temperature of the mixed water (MW) provided to the water consumer. FIG. 1 shows a temperature sensor 21 assigned to the supply pipe 18. Said temperature sensor 21 provides the measurement signal as input data 25 to the controller 17.

The determined desired consumer water temperature of the mixed water (MW) is automatically stored within the controller 17 of the water heater 10. The controller 17 may store the determined desired consumer water in a database 26 like a cloud database. The controller 17 may be connected with the database 26 through the internet 28.

As described above, the heating unit 11 of the water heater 10 is operated by the controller 17 on basis of the determined desired consumer water temperature such that the water temperature of the heated water HW heated by the water heater 10 corresponds to the desired consumer water temperature of the at least one water consumer. For this purpose, the controller 17 generates as output signal 27 a control signal for the heating unit 11 on basis of the desired consumer water temperature and provides the same to the heating unit 11.

The controller 17 controls the operation of the heating unit 11 on basis of that control signal (output signal 27) such that the water temperature of the heated water HW provided by the heating unit 11 corresponds to the desired consumer water temperature determined by the controller 17 and stored within the controller 17. Thereby it is possible to minimize the amount of unheated water CW mixed with the heated water HW and to provide an energy efficient operation of the water heater 10.

The controller 17 may also generate as output signal 29 a control signal for mixing valve 16 to automatically adjust the flow of unheated water CW to be mixed with the heated water HW.

The controller 17 may be further configured to determine the desired consumer water temperature of the mixed water MW provided to the at least one water consumer individually for defined time intervals of a day and/or for defined days of the week or of a month and/or for defined months of a year. This is especially of advantage if the water handling unit 13 of the water heater is provided by a water tank which stores a defined volume of heated water HW even if the is no actual demand of heated water HW.

The controller 17 may be configured to determine from the desired consumer water temperature of the mixed water MW determined individually for defined time intervals of a day and/or for defined days of the week or of a month and/or for defined months of a year a nominal hot water profile.

The controller 17 may then control operation of the heating unit 11 in such a manner that the water temperature of the heated water stored within the tank follows the nominal hot water profile.

Such a nominal hot water profile may be adapted over the operation of the water heater 10, may be stored within the cloud database 26 and/or may be updated based on data received from the cloud database 26.

Such a nominal hot water profile may also take into account a minimal temperature of the heated water HW stored within the tank to prevent microbiological growth within the tank to prevent waterborne illness.

This disclosure describes an example process to operate a water heater (10) that includes at least the following steps: Heating unheated water (CW) using a heating unit (11) of the water heater (10) thereby providing heated water (HW). Mixing heated water (HW) with unheated water (CW) using a mixing valve (16) of the water heater (10) thereby providing mixed water (MW) to at least one water consumer, the mixed water (MW) having a desired consumer water temperature. Determining the desired consumer water temperature of the mixed water (MW) provided to the at least one water consumer. Operating the heating unit (11) of the water heater (10) on basis of the determined desired consumer water temperature using a controller (17) of the water heater (10) such that the water temperature of the heated water (HW) corresponds to the desired consumer water temperature of the at least one water consumer thereby minimizing the amount of unheated water (CW) mixed with the heated water (HW).

In one or more examples, the functions described above may be implemented in hardware, software, firmware, or any combination thereof. For example, the various components of controller 17, temperature sensors 19-21, database 26, internet 28 may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

The term “non-transitory” may indicate that the storage medium is not embodied in a carrier wave or a propagated signal. In certain examples, a non-transitory storage medium may store data that can, over time, change (e.g., in RAM or cache).

By way of example, and not limitation, such computer-readable storage media, may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

Also, any connection is properly termed a computer-readable medium. For example. if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Combinations of the above should also be included within the scope of computer-readable media.

Instructions may be executed by one or more processors, such as one or more DSPs, general purpose microprocessors, ASICs. FPGAs, or other equivalent integrated or discrete logic circuitry. Accordingly, the term “processor,” and processing circuitry as used herein, may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units. including one or more processors as described above, in conjunction with suitable software and/or firmware.

In some embodiments, a method to operate a water heater, includes heating unheated water using a heating unit of the water heater thereby providing heated water, mixing heated water with unheated water using a mixing valve of the water heater thereby providing mixed water to at least one water consumer, the mixed water having a desired consumer water temperature, determining the desired consumer water temperature of the mixed water provided to the at least one water consumer, operating the heating unit of the water heater on basis of the determined desired consumer water temperature using a controller of the water heater such that the water temperature of the heated water corresponds to the desired consumer water temperature of the at least one water consumer thereby minimizing the amount of unheated water mixed with the heated water.

In some embodiments, the desired consumer water temperature of the mixed water provided to the at least water consumer is determined on basis of data provided to the controller by the mixing valve.

In some embodiments, the desired consumer water temperature of the mixed water provided to the at least water consumer is calculated by the controller on basis of the temperature of the heated water, the temperature of the unheated water and flow rates of the heated water and unheated water through the mixing valve.

In some embodiments, the desired consumer water temperature of the mixed water provided to the at least water consumer is determined by measuring the temperature of the mixed water provided to the water consumer.

In some embodiments, the desired consumer water temperature of the mixed water provided to the at least one water consumer is determined individually for defined time intervals of a day and/or for defined days of the week or of a month and/or for defined months of a year.

In some embodiments, the determined desired consumer water temperature of the mixed water is automatically stored within the controller of the water heater.

In some embodiments, the determined desired consumer water temperature of the mixed water is automatically stored within a database connected with the controller through the internet.

In some embodiments, a controller to operate a water heater, the water heater including a heating unit configured to heat unheated water thereby providing heated water, the water heater further including a mixing valve con-figured to mix unheated water with heated water in order to provide mixed water to at least one water consumer having a desired consumer water temperature, the controller is configured to determine the desired consumer water temperature of the mixed water provided to the at least one water consumer, the controller is further configured to operate the heating unit of the water heater on basis of the determined desired consumer water temperature such that the water temperature of the heated water corresponds to the desired consumer water temperature of the at least one water consumer thereby minimizing the amount of un-heated water mixed with the heated water.

In some embodiments, a controller, wherein the controller is configured to automatically operate a water heater according to the above method.

In some embodiments, a water heater includes a heating unit configured to heat unheated water thereby providing heated water, a mixing valve configured to mix unheated water with heated water in order to provide mixed water to at least one water consumer having a desired consumer water temperature, a controller.

1. A method to operate a water heater, the method comprising:
heating unheated water using a heating unit of the water heater thereby providing heated water,
mixing heated water with unheated water using a mixing valve of the water heater thereby providing mixed water to at least one water consumer, the mixed water having a desired consumer water temperature,
determining the desired consumer water temperature of the mixed water provided to the at least one water consumer,
operating the heating unit of the water heater on basis of the determined desired consumer water temperature using a controller of the water heater such that the water temperature of the heated water corresponds to the desired consumer water temperature of the at least one water consumer thereby minimizing an amount of unheated water mixed with the heated water.

2. The method of claim 1, wherein the desired consumer water temperature of the mixed water provided to the at least one water consumer is determined on basis of data provided to the controller by the mixing valve.

3. The method of claim 2, wherein the desired consumer water temperature of the mixed water provided to the at least one water consumer is calculated by the controller on basis of the temperature of the heated water, the temperature of the unheated water and flow rates of the heated water and unheated water through the mixing valve.

4. The method of claim 1, wherein the desired consumer water temperature of the mixed water provided to the at least one water consumer is determined by measuring the temperature of the mixed water provided to the water consumer.

5. The method of claim 1, wherein the desired consumer water temperature of the mixed water provided to the at least one water consumer is determined individually for defined time intervals of a day and/or for defined days of the week or of a month and/or for defined months of a year.

6. The method of claim 1, wherein the determined desired consumer water temperature of the mixed water is automatically stored within the controller of the water heater.

7. The method of claim 1, wherein the determined desired consumer water temperature of the mixed water is automatically stored within a database connected with the controller through the internet.

8. A controller to operate a water heater,
the water heater comprising a heating unit configured to heat unheated water thereby providing heated water,
the water heater further comprising a mixing valve con-figured to mix unheated water with heated water in order to provide mixed water to at least one water consumer having a desired consumer water temperature,
the controller is configured to determine the desired consumer water temperature of the mixed water provided to the at least one water consumer,
the controller is further configured to operate the heating unit of the water heater on basis of the determined desired consumer water temperature such that the water temperature of the heated water corresponds to the desired consumer water temperature of the at least one water consumer thereby minimizing an amount of unheated water mixed with the heated water.

9. The controller of claim 8, wherein the controller is configured to automatically operate a water heater according to the method of one claim 1.

10. A water heater, comprising:
a heating unit configured to heat unheated water thereby providing heated water,
a mixing valve configured to mix unheated water with heated water in order to provide mixed water to at least one water consumer having a desired consumer water temperature,
the controller of claim 8.

11. The method of claim 2, wherein the desired consumer water temperature of the mixed water provided to the at least water consumer is determined by measuring the temperature of the mixed water provided to the water consumer.

12. The method of claim 3, wherein the desired consumer water temperature of the mixed water provided to the at least water consumer is determined by measuring the temperature of the mixed water provided to the water consumer.

13. The method of claim 2, wherein the desired consumer water temperature of the mixed water provided to the at least one water consumer is determined individually for defined time intervals of a day and/or for defined days of the week or of a month and/or for defined months of a year.

14. The method of claim 3, wherein the desired consumer water temperature of the mixed water provided to the at least one water consumer is determined individually for defined time intervals of a day and/or for defined days of the week or of a month and/or for defined months of a year.

15. The method of claim 4, wherein the desired consumer water temperature of the mixed water provided to the at least one water consumer is determined individually for defined time intervals of a day and/or for defined days of the week or of a month and/or for defined months of a year.

16. The method of claim 2, wherein the determined desired consumer water temperature of the mixed water is automatically stored within the controller of the water heater.

17. The method of claim 3, wherein the determined desired consumer water temperature of the mixed water is automatically stored within the controller of the water heater.

18. The method of claim 4, wherein the determined desired consumer water temperature of the mixed water is automatically stored within the controller of the water heater.

19. The method of claim 2, wherein the determined desired consumer water temperature of the mixed water is automatically stored within a database connected with the controller through the internet.

20. The method of claim 6, wherein the determined desired consumer water temperature of the mixed water is automatically stored within a database connected with the controller through the internet.
